(19) United States
(12) Patent Application Publication
(10) Pub. No.: US 2012/0035323 A1
(43) Pub. Date: Feb. 9, 2012

(54) POLYOLEFIN/POLYLACTIC ACID BLENDS

(75) Inventor: Zuzanna Donnelly, Wayne, PA (US)

(73) Assignee: Arkema Inc., Kingo of Prussia, PA (US)

(21) Appl. No.: 13/264,433

(22) PCT Filed: Apr. 12, 2010
(86) PCT No.: PCT/US10/30715

§ 371 Date: Oct. 14, 2011

Related U.S. Application Data
(62) Division of application No. 61/169,019, filed on Apr. 14, 2009.

(51) Int. Cl. C08L 67/04; C08L 23/06; C08L 33/06; C08L 51/06; C08L 53/00

(52) U.S. Cl. 525/64; 525/190; 525/92 R

(57) ABSTRACT

The invention relates to blends of polyolefins and a biodegradable polymer, such as polylactic acid (PLA) and polyhydroxy butyrate, which are compatabilized by a functionalized olefin (meth)acrylic copolymer. Since PLA and polyolefins are not miscible, the use of the compatibilzer improves the compatibility, thereby improving the processability, and particularly the melt strength and melt elasticity. Useful compatibilizers include Lotader® and Lotryl® copolymers from Arkema, Inc. The blend composition may optionally contain one or more acrylic copolymers as impact modifiers or process aids.

### FIELD OF THE INVENTION

The invention relates to blends of polyolefins and a biodegradable polymer, such as polylactic acid (PLA) and polyhydroxy butyrate, which are compatabilized by a functionalized olefin (meth)acrylic copolymer. Since PLA and polyolefins are not miscible, the use of the compatibilzer improves the compatibility, thereby improving the processability, and particularly the melt strength and melt elasticity. Useful compatibilizers include Lotader® and Lotryl® copolymers from Arkema, Inc. The blend composition may optionally contain one or more acrylic copolymers as impact modifiers or process aids.

### BACKGROUND OF THE INVENTION

The growing global concern over persistent plastic waste has generated much interest in biodegradable polymers for everyday use. Biodegradable polymers based on polylactic acid (PLA) are one of the most attractive candidates as they can be readily produced from renewal agricultural sources such as corn. Recent developments in the manufacturing of the polymer economically from agricultural sources have accelerated the polymers emergence into the biodegradable plastic commodity market.

It is often desirable to blend PLA and other biopolymers with other traditional polymers, to take advantage of properties of the other polymers. One widely used, and inexpensive class of polymers are the polyolefins. Unfortunately, polyolefins and PLA are not miscible, and produce a melt having a very low melt strength and low melt elasticity that is difficult for processors to work with and shape into desired plastic articles.

Olefin acrylate polymers have been used as tie layers between polyolefins and poly(meth)acrylates, as shown in U.S. Pat. No. 6,455,171.

US 2007/0255013 described a blend of at least 50 wt % PLA with other polymers, including ethylene/unsaturated copolymers such as ethylene/glycidyl(meth)acrylate and ethylene/alkyl acrylate copolymers to enhance the heat-seal strength and toughness of the PLA.

US 2005/0154114 describes the use of compatibilizers with blends of two biopolymers. The polymeric compatibilizers are block copolymers of the two biopolymers, or polyacrylates miscible with PLA.

WO08149943 discloses a polyolefin film, containing at least 70 wt % of polyolefin, modified with a small amount of PLA, using a compatibilizer.

U.S. Pat. No. 7,381,772 describes the use of glycidyl-functional olefins as impact modifiers for PLA alone.

Applicant has now found that low levels of ethylene-(meth)acrylate copolymers added to a blend of PLA and polyolefins, provides compatibilization that greatly produces the processibility of the blend.

### SUMMARY OF THE INVENTION

The invention relates to a miscible, homogeneous polymer blend comprising:
a) from 20 to 80 weight percent of one or more biodegradable polymers;
b) from 20 to 80 weight percent of one or more polyolefins;
c) from 1 to 20 weight percent of one or more olefin acrylate copolymer compatibilizers, based on the total of a)+b); and
   optionally from 0-25 weight percent of one or more acrylic copolymers, based on the total of a)+b).

### BRIEF DESCRIPTION OF THE DRAWINGS

FIGS. 1-4 are AFM images showing the blend morphology of Sample 1 (comparative) and Samples 3, 10, and 11 of the invention.

### DETAILED DESCRIPTION OF THE INVENTION

The invention relates to blends of biodegradable polymers and polyolefins compatibilized with an olefin acrylate copolymer.

The biodegradable polymers of the present can be a single biodegradable polymer, or a mixture of biodegradable polymers. Some examples of biodegradable polymers useful in the invention include, but are not limited to, polylactic acid (PLA) and polyhydroxy butyrate, with polylactic acid being most preferred.

The PLA may be a homopolymer, of L-lactic acid, D-lactic acid, or a D,L-lactic acid representing various racemic mixtures of L-lactic acid and D-lactic acid. The PLA could also be a copolymer containing least 50 wt % lactic acid monomer, preferably at least 60, 70, 80, or 90 wt % lactic acid copolymerized with one of more other comonomers polymerizable with lactic acid. The PLA preferably has a weight average molecular weight of at least 100,000 g/mol.

The polyolefins (PO) useful in the invention are one or more unfunctionalized, semicrystalline or crystallizable olefin polymers including homopolymers, copolymers, terpolymers, or mixtures thereof, etc., containing one or more olefin monomeric units. The polyolefin may also be an olefin alloy, or a blend of olefinic homopolymers or copolymers with other miscible polymers. The polyolefin component makes up at least 51 percent by weight of any blend or copolymer, preferably at least 60 weight percent, 70 weight percent, 80 weight percent, 90 weight percent and up to 100 weight percent.

Polymers of alpha-olefins or 1-olefins are preferred in the present invention, and these alpha-olefins may contain from 2 to about 20 carbon atoms. Alpha-olefins containing 2 to about 6 carbon atoms are preferred. Useful olefins can be of any density such as high density polyethylene (HDPE), medium density polyethylene (MDPE), low density polyethylene (LDPE), and linear low density polyethylene (LLDPE). The olefin polymers are preferably derived from olefins such as ethylene, propylene, 1-butene, 1-pentene, 4-methyl-1-pentene, 1-octene, 1-decene, 4-ethyl-1-hexene, etc. Examples of polyolefins include polypropylene, polyethylene, and ethylene propylene copolymers. The polyolefin may also be a thermoplastic polyolefin (TPO), or a metallocene polyethylene. Blends of different polyolefins are also anticipated.

The olefin (meth)acrylate copolymer compatibilizer of the invention may be functionalized or unfunctionalized, and may be an acrylate, methacrylate, or mixtures of two or more olefin (meth)acrylates. Two or more different olefin acrylate copolymers may be used The preferred olefin monomer in these copolymers is ethylene, and the preferred acrylate monomers in these copolymers are selected from the group consisting of methyl acrylate, ethyl acrylate, propyl acrylate, butyl acrylate, pentyl acrylate, and hexyl acrylate, with methyl acrylate and butyl acrylate being presently most preferred. Generally, the acrylate content of the copolymers is from about 15% to about 30% by weight, with the balance being olefin.

Examples of suitable unfunctionalized olefin acrylate copolymers include, but are not limited to: ethylene butyl acrylate (EBA) copolymers, ethylene methyl acrylate (EMA) copolymers, and ethylene 2-ethylhexyl acrylate—such as those available under the trade name LOTRYL from Arkema Inc. Suitable functionalized olefin acrylate copolymers include, but are not limited to ethylene-n-butyl acrylate-maleic anhydride terpolymers, ethylene-ethyl acrylate-maleic anhydride terpolymers, a copolymer of ethylene and glycidyl methacrylate, and terpolymers of ethylene-methyl acrylate-glycidyl methacrylate—available under the trade name LOTADER from Arkema Inc. These copolymers generally comprise a major portion by weight of an olefin monomer, usually ethylene, and a minor portion, typically up to about 30% by weight, of an acrylic monomer, usually methyl acrylate or butyl acrylate.

The ratio of the PLA or other biodegradable polymer to the polyolefin is from 80/20 to 20/80 by weight. In one preferred embodiment, the level of PLA is at least 40 percent by weight, and in one embodiment the PLA makes up 50 weight percent or more of the polyolefin/PLA blend. The compatibilizer is added to the PLA/PO blend at a level of from 1-20 weight percent, and preferably at from 1-10 weight percent, based on the weight of the total blend composition of PLA, PO, and olefin acrylate copolymer(s).

If the polyolefin component of the blend is a copolymer of a polyolefin and an acrylic polymer, such as an ethylene methyl acrylate, then a functional olefin acrylate (such as a LOTADER resin) preferably is also used.

The blend composition of the invention optionally contains 0-25 weight percent of one or more acrylic copolymers, and preferably from 1 to 20 weight percent. The acrylic copolymers primarily serve one of two purposes: as an impact modifier or as a process aid. By “copolymers” as used herein is meant polymers having two or more different monomer units—including terpolymers and polymers having 3 or more different monomers.

One or more acrylic copolymer impact modifiers may be added to the polymer blend at from 0.1 to 15 and preferably from 3 to 10 weight percent of the blend composition (PLA/PO/compatibilizer). The impact modifier can be a linear block copolymer, terpolymer, or tetramer; or a core/shell impact modifier. Useful linear block copolymers include, but are not limited to, acrylic block copolymers, and SBM-type (styrene, butadiene, methacrylate) block polymers. The block copolymers consists of at least one “hard” block, and at least one “soft” block. The hard blocks generally have a glass transition temperature (Tg) of greater than 20° C., and more preferably greater than 50° C. Preferably, the hard block is composed primarily of methacrylate ester units, styrenic units, or a mixture thereof. Preferably the soft block is composed mainly of acrylate ester units or dienes.

One or more acrylic copolymer process aids may also be added to the PLA/PO/compatibilizer blend at from 1 to 15 weight percent based on the weight of the PLA/PO. The copolymers could be random, block, gradient or of other architectures. “Acrylic copolymers” as used herein, refers to copolymers having 60 percent or more of acrylic and/or methacrylic monomer units. “(meth)acrylate” is used herein to include both the acrylate, methacrylate or a mixture of both the acrylate and methacrylate. Useful acrylic monomers include, but are not limited to methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, amyl (meth)acrylate, isoamyl (meth)acrylate, n-hexyl (meth)acrylate, cycloheyl (meth)acrylate, 2-ethylhexyl (meth)acrylate, pentadecyl (meth)acrylate, dodecyl (meth)acrylate, isobornyl (meth)acrylate, phenyl (meth)acrylate, benzyl (meth)acrylate, phenoxyethyl (meth)acrylate, 2-hydroxyethyl (meth)acrylate and 2-methoxyethyl (meth)acrylate, maleic anhydride and/or glycidyl methacrylate. Preferred acrylic monomers include methyl acrylate, ethyl acrylate, butyl acrylate, and 2-ethyl-hexyl-acrylate, methyl methacrylate, ethyl methacrylate, and butyl methacrylate.

In addition to the acrylic monomer units, the acrylic copolymer process aid may also include up to 40 percent of other ethylenically unsaturated monomers polymerizable with the acrylic monomers, including, but not limited to styrene, alpha-methyl styrene, butadiene, vinyl acetate, vinylidene fluorides, vinylidene chlorides, acrylonitrile, vinyl sulfone, vinyl sulfides, and vinyl suloxides. In one embodiment, the copolymer contains styrene.

In one embodiment, the acrylic copolymer contains both acrylate and methacrylate monomer units. As and example, the process aid may be a terpolymer of methyl methacrylate-butyl acrylate-butyl methacrylate with a butyl methacrylate content of 20% having a weight average molecular weight of 300,000 g/mol.

In another embodiment, the acrylic copolymer process aid comprises 10-75 weight percent of methyl methacrylate units, 10 to 50 weight percent of butyl acrylate units, 0 to 50 weight percent of butyl methacrylate units, and from 0 to 80 weight percent of styrene, the total adding to 100 percent.

The acrylic copolymer process aid generally has a weight average molecular weight in the range of 10,000 to 3,000,000 g/mol.

In addition to the biodegradable polymer, polyolefin, compatibilizer and impact modifier, the composition of the invention may additionally contain a variety of additives, including but not limited to, heat stabilizers, internal and external lubricants, other impact modifiers, process aids, melt strength additives, fillers, and pigments.

The ingredients may be admixed prior to processing, or may be combined during one or more processing steps, such as a melt-blending operation. This can be done, for instance by single-screw extrusion, twin-screw extrusion, Buss kneader, two-roll mill, impeller mixing. Any admixing operation resulting in a homogeneous distribution of the various components is acceptable. Formation of the blend is not limited to a single-step formation. Masterbatches may be used for the addition of one or more components of the blend composition.

### EXAMPLES

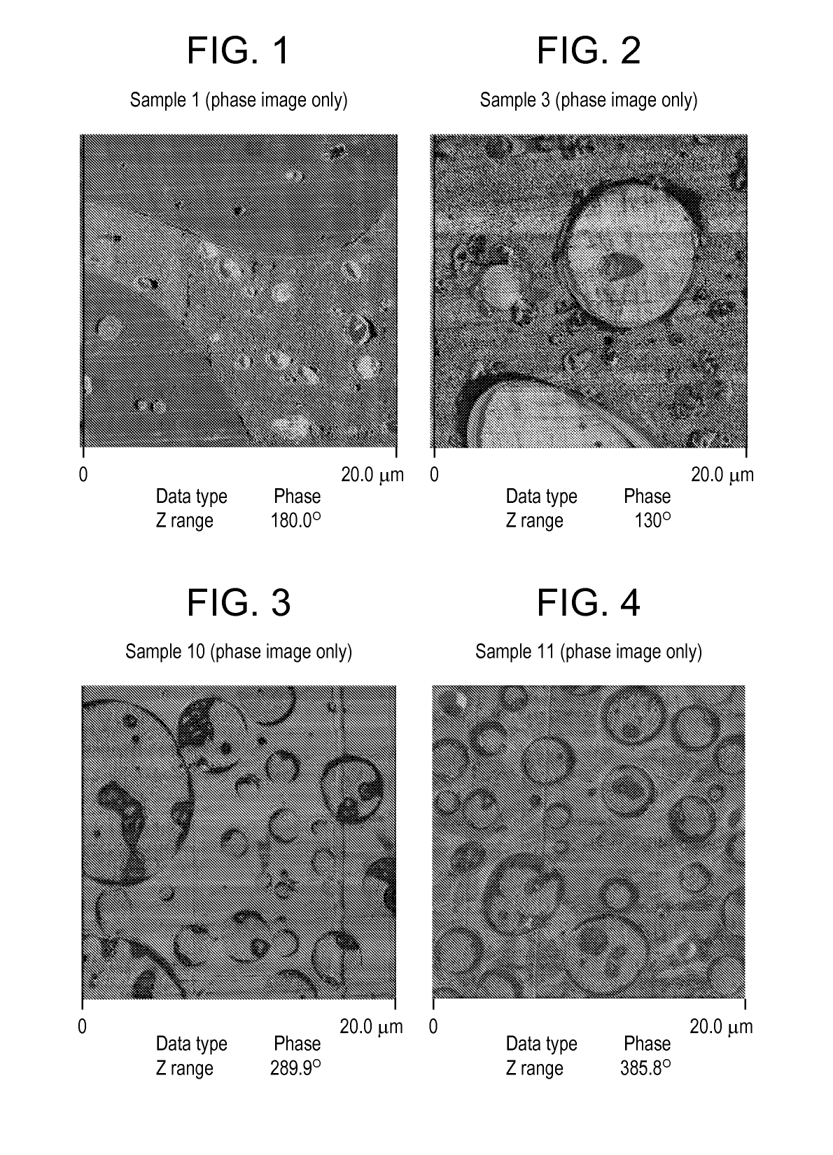

A series of blends of PLA and polypropylene with different amounts of LOTADER or LOTRYL additives were made on a Thermo Haake 15 mm twin screw extruder. These blends are summarized in Table 1 below. The control samples that did not contain any additives demonstrated melt of very poor quality that could not be pulled into strands for pelletizing. Samples containing additives gave melts that were easily pulled into strands and pelletized. AFM imaging revealed large differences in blend morphology (FIG. 1—Sample 1, FIG. 2—Sample 3, FIG. 3—Sample 10, and FIG. 4—Sample 11) as described in Table 1.

LOTADER and LOTRYL are trademarks of Arkema.
LOTADER 6200=ethylene/ethyl acrylate/maleic anhydride (88.9/6.5/3.6)
LOTADER 4603=ethylene/methyl acrylate/maleic anhydride (73.7/26/0.3)
LOTYL 29MA03=ethylene/methyl acrylate (71/29
LOTADER 4700=ethylene/ethyl acrylate/maleic anhydride (69.7/29/1.3)
LOTADER AX 8900=ethylene/methyl acrylate/glycidyl methacrylate (68/24/8)
LOTADER AX 8840=ethylene/glycidyl methacrylate (92/8)

TABLE 1

| sample # | PLA/PP ratio | additive | AFM Images |
|---|---|---|---|
| 1 | 50/50 | none | Thick asymmetric domains of dimensions 5-80 μm on the long axis |
| 2 | 50/50 | 5% Lotader AX 6200 | Thin asymmetric domains of dimensions 5-90 μm on the long axis |
| 3 | 50/50 | 5% Lotader AX 4603 | Domains of ellipsoid shape and dimensions of 2-55 μm on the long axis |
| 4 | 50/50 | 15% Lotader AX 4603 | Spherical domains of dimensions 2-15 μm were observed. |
| 5 | 50/50 | 5% Lotryl 29MA03 | Thin asymmetric domains of dimensions 10-110 μm on the long axis |
| 6 | 50/50 | 5% Lotader AX 4700 | Thick asymmetric domains of dimensions 10-200 μm on the long axis |
| 7 | 50/50 | 5% Lotader AX 8900 | Thick asymmetric domains of dimensions 5-190μm on the long axis |
| 8 | 50/50 | 5% Lotader AX 8840 | Thin asymmetric domains of dimensions 2-120 μm on the long axis |
| 9 | 25/75 | 5% Lotader AX 4603 | Spherical domains of dimensions 1-7 μm were observed. |
| 10 | 75/25 | 5% Lotader AX 4603 | Spherical domains of dimensions 0.7-12 μm were observed. |
| 11 | 75/25 | 15% Lotader AX 4603 | Spherical domains of dimensions 1-5 μm were observed. |

1. A miscible, homogeneous polymer blend comprising:
a) from 20 to 80 weight percent of one or more biodegradable polymers;
b) from 20 to 80 weight percent of one or more unfunctionalized polyolefins;
c) from 1 to 20 weight percent of one or more olefin (meth)acrylate copolymer compatibilizers, based on the total weight of a)+b); and
d) optionally from 0-25 weight percent of one or more acrylic copolymers, based on the total weight of a)+b).

2. The polymer blend of claim 1 wherein said biodegradable polymer is selected from the group consisting of polylactic acid, polyhydroxy butyrate, and mixtures thereof.

3. The polymer blend of claim 1, comprising 40 to 80 weight percent of one or more biodegradable polymers.

4. The polymer blend of claim 1, comprising 50 to 80 weight percent of one or more biodegradable polymers.

5. The polymer blend of claim 1, comprising from 1 to 10 weight percent of one or more olefin (meth)acrylate copolymer compatibilizers.

6. The polymer blend of claim 1, wherein said polyolefin is polyethylene, polypropylene, or mixtures thereof.

7. The polymer blend of claim 1, wherein the polyolefin is a thermoplastic polyolefin.

8. The polymer blend of claim 1, wherein the olefin (meth)acrylate copolymer comprises of 51 to 99 weight percent of olefin monomer(s) and 1 to 49 weight percent of acrylic monomer(s).

9. The polymer blend of claim 1, wherein said acrylic copolymers are selected from is one or more process aids and/or one or more impact modifiers.

10. The polymer blend of claim 9, wherein said impact modifiers are selected from a linear block copolymer or a core/shell graft copolymer.

11. The polymer blend of claim 9, wherein said one or more process aids comprise 10 to 75 weight percent of methyl methacrylate units, 10 to 50 weight percent of butyl acrylate units, 0 to 50 weight percent of butyl methacrylate units, and from 0 to 80 weight percent of styrene.

12. The polymer blend of claim 1, wherein said olefin (meth)acrylate copolymer compatibilizer is selected from copolymers of ethylene/butyl acrylate, ethylene/methyl acrylate, ethylene/2-hexyl acrylate, ethylene/glycidyl methacrylate, ethylene/methyl acrylate/glycidyl methacrylate, ethylene/maleic anhydride, ethylene/butyl acrylate/maleic anhydride, ethylene/methyl acrylate/maleic anhydride, ethylene/ethyl acrylate/maleic anhydride, or mixtures thereof.

13. The polymer blend of claim 1, wherein said polyolefin (b) comprises a polyethylene and said compatibilizer (c) comprises a functionalized olefin (meth)acrylate.

14. The polymer blend of claim 1, comprising from 1-20 weight percent of said acrylic copolymers (d).
